(19) United States
(12) Patent Application Publication
(10) Pub. No.: US 2010/0169715 A1
(43) Pub. Date: Jul. 1, 2010

(54) Process for Verifying Computers

(75) Inventors: Daniel Paul Aicher, Hartland, WI (US); Lucian G. Suchocki, Mukwonago, WI (US); John Ashley Blankenship, Hartland, WI (US)

Correspondence Address: REINHART BOERNER VAN DEUREN P.C., 2215 PERRYGREEN WAY, ROCKFORD, IL, 61107, US

(73) Assignee: Dedicated Computing LLC, Waukesha, WI (US)

(21) Appl. No.: 12/344,786

(22) Filed: Dec. 29, 2008

(51) Int. Cl. G06F 11/00

(52) U.S. Cl. 714/38; 714/E11.001

(57) ABSTRACT

A process for verifying computers is provided. The process characterizes a golden sample computer preconfigured to customers' configuration preferences, and stores the results and links the results to the specific customers. The process then checks output computers by retrieving the appropriate characterization results and verifying the output computers based on the characterization results. If the output computer passes, it is shipped, but if it fails, it can be easily reconfigured based on the results of the verification phase.

### FIELD OF THE INVENTION

This invention generally relates to computer manufacturing and, more particularly, to automatic characterization of a build standard and verification of a fully assembled and configured computer during the manufacture process.

### BACKGROUND OF THE INVENTION

Purchasers of computers often require that their computers arrive assembled and configured to their particular preferences. Customers also typically have different configuration needs. Therefore, computers for different customers must be assembled and configured differently. As such, different outgoing product computers may have different hardware and firmware, including different Basic Input-Output System (“BIOS”) settings and firmware revision levels and different operating system images depending on each customer's desired configuration. Producing such non-uniform products creates unique quality control challenges.

Customized computers are often assembled manually. This means that an individual assembler connects hardware components to motherboards, places cards in motherboard slots and loads BIOS settings and customer images, for example. It is essential that every connection be properly made and every card be placed in the correct slot. Mistakes in assembly can result in a decrease in customer satisfaction, as well as an increase in costs, as each incorrectly configured computer must be returned and reconfigured.

Verifying that each computer is configured according to its customer's preferences is an important step in the assembly process. However, checking non-uniform products requires that the checker know for which customer a particular product is configured, as well as what particular configuration each customer requires. In the past, individual assemblers would need to know for what customer a product was built, determine what configuration the customer required, and then check the work of all the assemblers upstream (those who had worked on the computer previously). However, this verification process was not only time consuming, but would result in incorrectly configured computers still periodically arriving at a customer's location due to human error.

Based on these problems it would be advantageous to have a verification process flexible enough to verify different configurations of hardware and firmware on computers for different customers with different configuration needs. It would also be advantageous to have a verification process that minimized the possibility of human error into the verification process. In addition, it would be advantageous to have a verification process that could probe model computers configured to customer specification to gather and store the configuration information for each customer. Finally, it would be advantageous if the verification process could store the configuration information of multiple customers, and retrieve this configuration information to verify the configurations of other computers for these customers.

The invention provides such advantages. These and other advantages of the invention, as well as additional inventive features, will be apparent from the description of the invention provided herein.

### BRIEF SUMMARY OF THE INVENTION

In one aspect, embodiments of the current invention provide several functions vital to the verification of computers in a production environment. Before production of computers for a particular customer begins, the customer states all configuration preferences. A model computer, called a golden sample computer, is then assembled and configured according to the particular customer's preferences. The characterization phase of one embodiment of the current invention then probes the golden sample computer to determine all aspects of its configuration including, its hardware bill of materials, all BIOS settings and firmware revision levels, connections of the hardware, including card locations, hard drive connections and USB and serial connections and information regarding the operating system image. In one embodiment, the characterization phase then stores this configuration information in a characterization file specific to this particular customer. This is repeated for multiple customers.

The verification phase is then implemented in a production environment. Many output computers with many different configurations are assembled in the production environment. The verification phase begins by determining the customer of a designated output computer. In one embodiment, the verification phase then retrieves the characterization file linked to that customer. The verification phase uses that characterization file to verify the configuration of the output computer. The results of the verification are recorded. If the output computer passes verification, it is shipped to it's customer's location. If the output computer fails verification, the results of the verification are used to quickly and precisely rework the output computer and reconfigure whatever part or parts of the verification failed. Once the output computer is reconfigured it can once again go through the verification process to assure that it was reconfigured correctly.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a simplified process flow diagram illustrating an embodiment of a process for verifying computers based on a characterization of a golden sample constructed in accordance with the teachings of the present invention;

FIG. 2 is a flow diagram illustrating in greater detail an embodiment of the characterization phase of the process of FIG. 1; and

FIG. 3 is a flow diagram illustrating in greater detail an embodiment of the verification phase of the process of FIG. 1.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

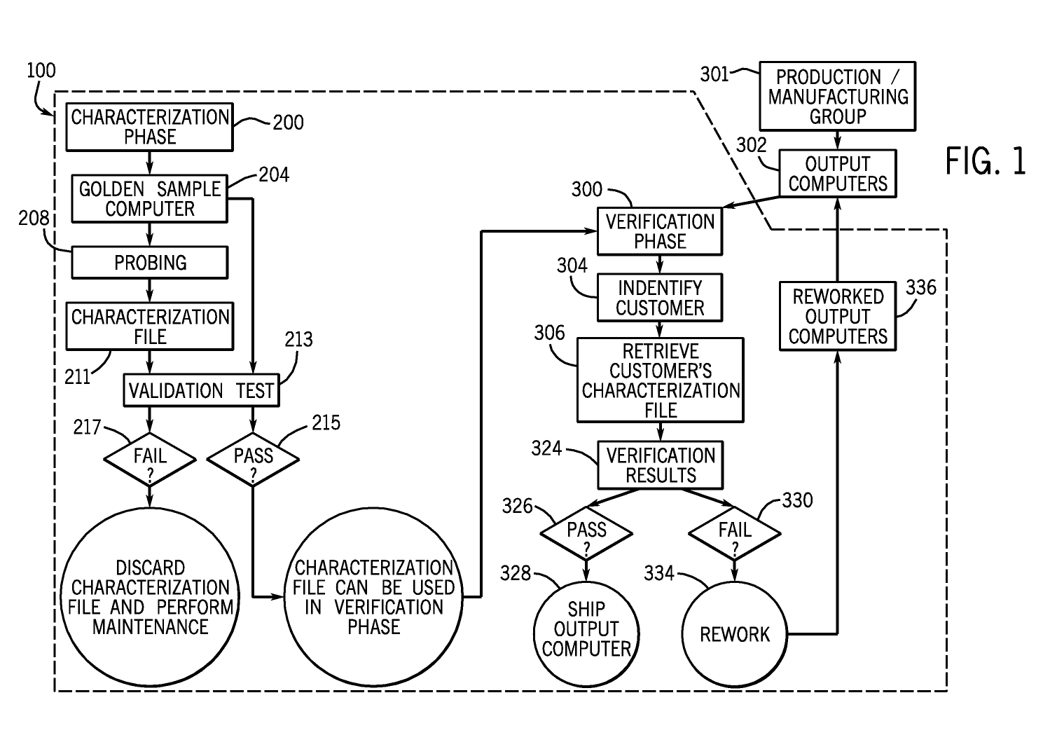

Referring to FIG. 1, a process for verifying computers 100 constructed in accordance with one embodiment of the present invention is illustrated. As will be more fully explained below, the process for verifying computers 100 is designed with three goals. First, the process 100 is designed to gather basic information about a computer under test. Second, the process 100 is designed to store this information. Third, the process 100 is designed to use that stored information to test a computer that has been manufactured with the same design. As will be explained more fully below, in one embodiment, a golden sample computer is configured to a customer's preferences. This golden sample computer goes through a probing process to determine the characteristics of the golden sample. These characteristics are used to test other output computers. If the output computer passes the test, the output computer producer is assured that the output computer is configured according to the customer's specifications. If the output computer fails, the results of the test can be used to precisely identify what is wrong with the output computer so that it can be reconfigured quickly and easily. An embodiment of the invention will be more fully explained below.

Referring to FIG. 1, in one embodiment, the process 100 has two phases: a characterization phase 200 and a verification phase 300. Generally, during the characterization phase 200 the information about a particular customer's configuration preferences is gathered and stored. The information is gathered during a probing process 208 by probing a sample computer already configured to a particular customer's requirements, referred to as a golden sample computer 204. In one embodiment, the details of the golden sample computer's 204 configuration are then stored in a characterization file 211 for use in the validation test 213 and the verification phase 300. The characterization phase 200 will only need to be completed once for each customer order or configuration unless the customer's configuration preferences change.

The validation test 213 is then performed on the characterization file 211. In general, this consists of putting the golden sample computer 204 through the verification phase 300 using the characterization file 211. Since the golden sample computer 204 was used to create the characterization file 211, the golden sample computer 204 should always complete the verification phase 300 successfully if the process 100 is functioning correctly. If the golden sample computer 204 does not complete the verification phase 300 successfully, then the process 100 is not functioning correctly so the characterization file is discarded and maintenance is performed.

The characterization phase 200 can be repeated and characterization files 211 can be produced for each customer. A development group 202 builds new golden sample computers 204 each configured to a different customer's preferences and each golden sample computer 204 undergoes the probing process 208. The characterization file 211 produced by each probing process 208 is linked to the identifying information of the customer for which the golden sample computer 204 was built. The characterization phase 200 will be discussed in more detail below.

Continuing on FIG. 1, outside the process 100, a production/manufacturing group 301 builds output computers 302 to fill customer orders. These output computers 302 enter the verification phase 300 of the process 100. The object of the verification phase 300 is to assure that output computers 302 are correctly configured based on a particular customer's preferences before the output computers are shipped 328 to the customer.

In one embodiment, the verification phase 300 uses the characterization file 244 produced during the characterization phase 200 to verify that an output computer 302 is correctly configured according to the particular customer's preferences. Because in this embodiment there are different characterization files 244 for each customer, the verification phase 300 can be run on output computers 302 for various customers to verify that each is setup according to its own customer's configuration preferences. Output computers 302 completing the verification phase 300 successfully are definitively configured according to their customer's preferences and are shipped to the customer's location 328. Output computers 302 that are unsuccessful 330 in completing the verification phase 300 are reworked 334 based upon the results 324 of the verification phase 300. The verification phase 300 will also be explained more fully below.

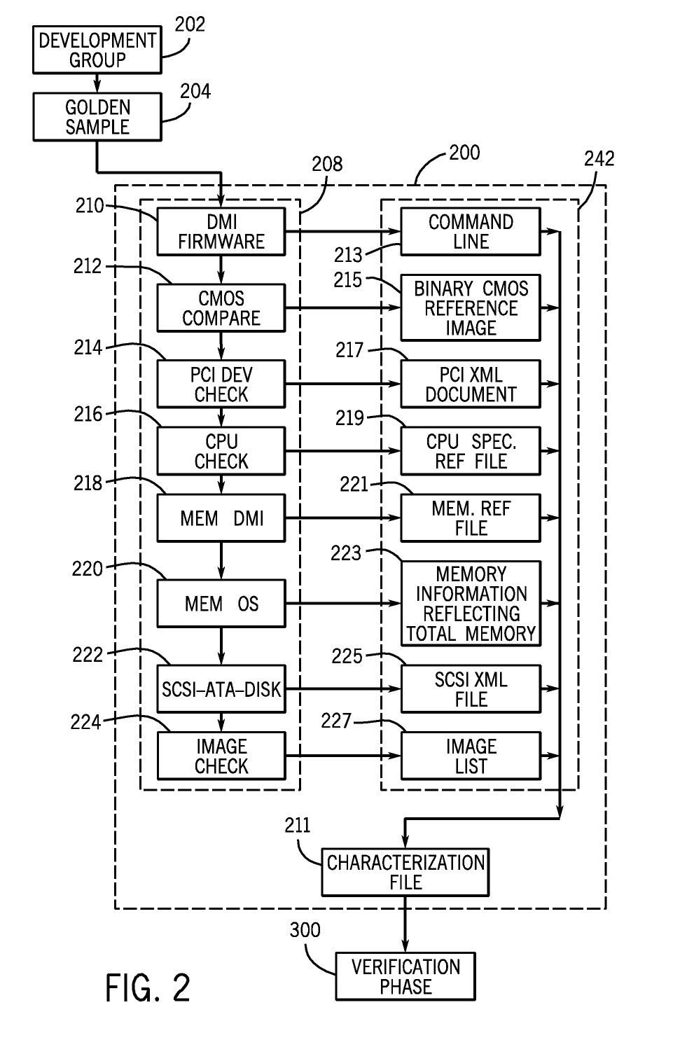

In this embodiment, before the process 100, the development group 202 obtains a customer's desired specifications. Referring to FIG. 2, the development group 202 then designs a golden sample computer 204 to match these specifications. Then the development group 202 initiates 206 the process 100 (see FIG. 1).

A more detailed explanation of the characterization phase 200 in one embodiment, as illustrated in FIG. 2, follows. To begin, the golden sample computer 204 enters the probing process 208. Referring to FIG. 2, the probing process 208 consists of several steps. In the Direct Media Interface (“DMI”) Firmware step 210, a user must select the serial number of the computer being probed from a list of detected values. A command line 226, which contains the BIOS ID, version, date and serial number when this data is gathered, is constructed.

In the Nonvolatile BIOS memory (referred to as “CMOS”)-Compare step 212, the BIOS CMOS information from ports 70h and 72h is captured. This information will be 256 bytes in total size, unless the data is the same at both locations. This information is then used to create a binary CMOS reference image 215.

In the pciDevCheck step 214, the Peripheral Component Interconnect (“PCI”) device information of the motherboard and PCI add-in devices is captured and stored in a PCI Extensible Markup Language (“XML”) document 217. Specifically captured are device locations, PCI PNP-ID and hardware revision. The device's manufacture and model information is also retrieved from the PCI PNP-ID and stored. The user is also asked at this point whether the revision number of the PCI device should be validated.

In the cpuCheck step 216, the Central Processing Unit (“CPU”) information is captured, including the physical and logical quantity of the CPUs, the speed, the CPU IDs, cache size and other parameters. This information is obtained from DMI, as well as the golden sample computer's 204 /proc/cpuinfo file. The information is formatted and stored in a cpuSpec.ref file 219.

In the memDMI step 218, a dmidecode tool is used to gather information about each memory chip inserted into the motherboard of the golden sample computer 204, specifically information regarding dual inline memory module (“DIMM”) slot number, size of the memory chip and speed of the memory chip. This information is stored in a mem.ref file 221.

In the memOS step 220 memory information is gathered from the golden sample computer's 204 operating system (“OS”) system file /proc/meminfo, reflecting the total memory as seen by the OS. This information is stored 223.

In the scsi-ata-disk step 222, information regarding the golden sample computer's 204 small computer system interface (“SCSI”) and Integrated Drive Electronics (“IDE”) disks and CD-ROMs is gathered, including models, firmware revision and which port these are connected to. This information is stored in an SCSI XML reference file 225.

In the imageCheck step 224, a list of files and details about the files including creation time and size from each partition of every hard disk is created. In this step the user is asked for the percentage of files to be compared during validation, the minimum percentage of files required to be exact in order to pass the validation, as well as the parameters that the user wishes to omit checking, e.g. time of last modification of the file, file size, file name, etc. This information is then stored in an image list 227.

In one embodiment, the command line 213, the binary CMOS reference image 215, the PCI XML document 217, the cpuSpec.ref file 219, the mem.ref file 221, the memory information reflecting total memory 223, the scsi XML file 225 and the image list 227 are all gathered into a characterization file 211 to be used in the verification phase 300.

In another embodiment, the command line 213, the binary CMOS reference image 215, the PCI XML document 217, the cpuSpec.ref file 219, the mem.ref file 221, the memory information reflecting total memory 223, the scsi XML file 225 and the image list 227 are all stored on a media instead of in a characterization file 211. Possible examples of a media are a floppy disk or a compact disk. A media is not limited to these examples, instead these examples are provided as an illustration of possible types of media. All other aspects of this alternate embodiment remain the same, other than the media replacing the characterization file 211 in all places.

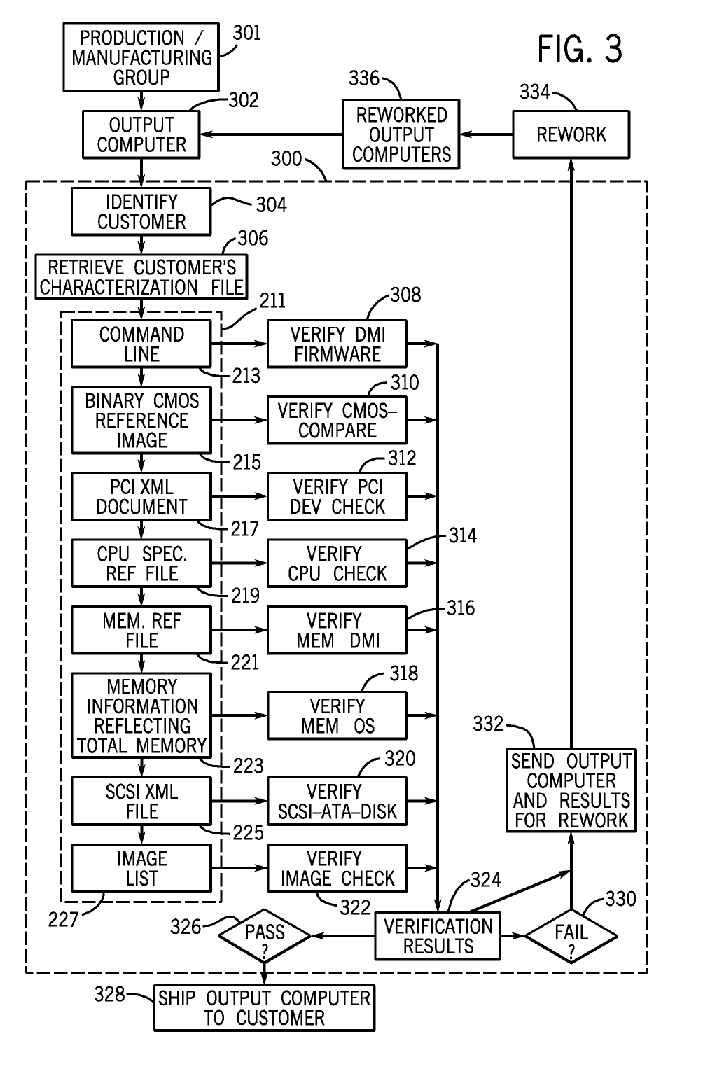

Referring to FIG. 1, in this embodiment the process 100 next verifies that the process 100 is functioning correctly. This is done by conducting the validation test 213 on the characterization file 211. In the validation test 213 the characterization file 211 that was produced when the golden sample computer 204 underwent the characterization phase 200 is used as an input to the verification phase 300, which will be explained in more depth below, and the golden sample computer 204 undergoes the verification phase 300. If the characterization phase 200 and the verification phase 300 are functioning correctly the golden sample computer 204 will successfully complete the verification phase 300 and therefore the characterization file 211 will pass 215 the validation test 213, indicating that the process 100 is functioning correctly, and that the characterization file 211 can be stored and used to output computers 302 in the verification phase 300 (see FIG. 3). If the golden sample computer 204 does not complete the verification phase 300 successfully, the characterization file 211 fails 217 the validation test 213 and is discarded, and maintenance is performed on the process 100.

In this embodiment, once it is confirmed that the process 100 is working correctly and that the characterization file 211 is correct, the verification phase 300 can be implemented. As is illustrated in FIG. 3, the verification phase 300 is performed on the output computers 302 from the production/manufacturing group 301 to verify that each output computer 302 is configured according to its customer's configuration preferences. First, the customer for the particular output computer 302 undergoing verification 300 is identified 304. The characterization file 211 produced by the characterization phase 200 (see FIG. 2) for this customer is retrieved 306. The verification phase 300 uses each part of the characterization file 211 to verify the output computer 302.

Returning to FIG. 3, in the verify DMI firmware step 308 all the data in the command line 213 (see FIG. 2) stored in the characterization file 211 is used to verify the output computer's 302 corresponding information. The results of the comparison are gathered and saved in the verification results 324. The serial number of the output computer 302 will vary, but it is recorded to link the verification results 324 to the output computer 302.

The verify CMOS-Compare step 310 uses the binary CMOS reference image 215 stored in the characterization file 211 to verify the output computer's 302 BIOS CMOS information. Some motherboard manufacturers randomly set non-checksummed, internally used values in the upper 128-255 byte range that do not reflect BIOS settings, and, as the majority of typical BIOS settings are contained in the lower 0-127 byte range, the upper half of the BIOS CMOS is not checked, and is expected to be inconsistent from board to board. The results of this step are again recorded in the verification results 324.

The verify pciDevCheck step 312 uses the PCI XML document 217 to verify the output computer's 302 motherboard device layout. The step 312 also verifies that all the PCI cards are of the correct manufacturer, model and revision number, and that they are located correctly on the motherboard. The results of this step 312 are stored in the verification results 324.

The verify cpuCheck step 314 uses the CPU specifications stored in the cpuSpec.ref file 219 to verify the CPU specifications of the output computer 302. The results of this step 314 are stored in the verification results 324.

The verify memDMI step 316 uses the mem.ref file 221 to check the output computer's 302 memory information as reported by the BIOS via DMI. Size, location and speed are all verified, and the results are stored in the verification results 324.

The verify memOS step 318 verifies the output computer's 302 total memory as seen by the output computer's 302 OS reported by the BIOS, using the memory information reflecting total memory 223 stored in the characterization file 211. The results of this step 318 are stored in the verification results 324.

The verify scsi-ata-disk step 320 uses the scsi XML file 225 to verify that the output computer's 302 scsi and IDE devices are of the correct type and are located properly. The results of this step 320 are stored in the verification results 324.

The imageCheck step 322 uses the image list 227 to check the output computer's 302 files of each partition of each disk according to the user parameters entered during the corresponding step 224 in the characterization phase 200. The results of the imageCheck step 322 are stored in the verification results 324. In one embodiment, the verification results 324 are displayed. In alternate embodiments the verification results can be displayed on a printout, on a screen, on a computer screen or via any other medium that would allow a user to see the verification results 324.

After the above steps have been completed, the verification results 324 are examined. If the output computer 302 passes 326, the output computer 302 is correctly configured according to its customer's preferences, and the output computer 302 is shipped to the customer's location 328. If the output computer 302 fails 330 however, the verification results 324 will indicate which step of the verification phase 300 was unsuccessful, and, therefore, which element of the output computer 302 is configured incorrectly. The output computer 302 and the verification results 324 are linked 332 and are sent back for rework 334. The rework 334 is able to be done effectively because the verification results 324 show exactly why the output computer 302 failed and what portion of the output computer 302 needs to be reconfigured. After the rework 334 is finished, the output computer 302 can be put through the verification phase 300 again before being shipped to the customer's location 328.

The verification phase 300 can be performed on an output computer 302 for any customer that has a characterization file 211, as the process is not specific to any one set of customer configuration preferences.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for verifying computers comprising:
creating a golden sample computer including hardware and firmware, the hardware and firmware each including specific characteristics;
probing the hardware and firmware of the golden sample computer to determine the specific characteristics of the hardware and firmware;
creating a characterization file;
storing the specific characteristics of the hardware and firmware determined from the step of probing in the characterization file;
loading the characterization file on an output computer;
verifying the output computer using the characteristics stored in the characterization file, the output computer including output computer characteristics and output computer firmware, the output computer hardware and the output computer firmware each including output computer characteristics;
determining a plurality of results of the verification; and
displaying at least one of the results of the verification.

2. The method of claim 1, wherein the stored characteristics are linked to a customer.

3. The method of claim 1, further comprising using the results of the verification to determine a destination for the output computer.

4. The method of claim 1, further comprising using the results of the verification of the output computer to reconfigure the output computer.

5. The method of claim 1, wherein the results are displayed on a print out.

6. The method of claim 1, wherein the results are displayed on a screen.

7. The method of claim 1, wherein the output computer is shipped to a customer's location when the results indicate a verification pass.

8. The method of claim 1, further comprising using a software tool to implement the method.

9. A computer-usable medium having computer readable instructions stored thereon for execution by a processor to perform a method comprising the steps of claim 1.

10. A method for verifying computers comprising:
creating a golden sample computer including specific hardware and specific firmware, the specific hardware and specific firmware each including characteristics;
probing the hardware and firmware of the golden sample computer to determine the characteristics of the specific hardware and specific firmware;
storing the characteristics of the hardware and firmware determined from the step of probing on a media;
loading characteristics stored on the media onto an output computer;
verifying the output computer using the stored characteristics, the output computer including output computer hardware and output computer firmware, the output computer hardware and output computer firmware each including output computer characteristics;
determining a plurality of results of the verification; and
displaying the results.

11. The method of claim 10, wherein the stored characteristics are linked to a customer.

12. The method of claim 10, further comprising using the results of the verification to determine a destination for the output computer.

13. The method of claim 10, further comprising using the results of the verification of the output computer to reconfigure the output computer.

14. The method of claim 10, wherein the results are displayed on a print out.

15. The method of claim 10, wherein the results are displayed on a screen.

16. The method of claim 10, wherein the output computer is shipped to a customer's location when the results indicate a successful verification.

17. The method of claim 10, further comprising using a software tool to implement the method.

18. A computer-usable medium having computer readable instructions stored thereon for execution by a processor to perform a method comprising the steps of claim 1O.

19. A method for verifying computers with the use of a characterization file created by
creating a golden sample computer including hardware and firmware, the hardware and firmware each including specific characteristics, probing the hardware and firmware of the golden sample computer to determine the specific characteristics of the hardware and firmware, creating a characterization file and storing the probed characteristics in the characterization file, the method comprising:
loading the characterization file on an output computer;
verifying the output computer using the characteristics stored in the characterization file, the output computer including output computer hardware and output computer firmware, the output hardware and output firmware each having output computer characteristics;
determining a plurality of results of the verification; and
displaying at least one of the results of the verification.

20. A computer-usable medium having computer readable instructions stored thereon for execution by a processor to perform a method comprising the steps of claim 19.

21. A method for creating a characterization file for use in verifying computers, the method comprising:
creating a golden sample computer including hardware and firmware, the hardware and firmware each including specific characteristics;
probing the hardware and firmware of the golden sample computer to determine the specific characteristics of the hardware and firmware;
creating a characterization file; and
storing the specific characteristics of the hardware and firmware determined from the step of probing in the characterization file.

22. A computer-usable medium having computer readable instructions stored thereon for execution by a processor to perform a method comprising the steps of claim 21.
